(19) United States
(12) Patent Application Publication
(10) Pub. No.: US 2006/0185780 A1
(43) Pub. Date: Aug. 24, 2006

(54) Pneumatic tire for passenger cars

(75) Inventor: Ryoji Hanada, Hiratsuka-shi (JP)

Correspondence Address: RADER FISHMAN & GRAUER PLLC, LION BUILDING, 1233 20TH STREET N.W., SUITE 501, WASHINGTON, DC, 20036, US

(73) Assignee: THE YOKOHAMA RUBBER CO., LTD.

(21) Appl. No.: 11/350,857

(22) Filed: Feb. 10, 2006

(30) Foreign Application Priority Data
Feb. 18, 2005 (JP) JP2005-041814

(51) Int. Cl. B60C 9/00

(52) U.S. Cl. 152/546; 152/556

(57) ABSTRACT

A pneumatic tire for passenger cars having at least one carcass ply extending between right and left beads through a tread, the at least one carcass ply having reinforcing cords that extend in the radial direction of the tire and are disposed at predetermined intervals in the circumferential direction of the tire, a plurality of belt plies being placed radially outwardly of the at least one carcass ply in the tread. A bead core is embedded in each of the right and left beads and a bead filler is disposed radially outwardly of the bead core, the bead filler having a radially outer edge that is located at a position closer to the radially inner side of the tire than a position of 50% of the section height of the tire. The mean residual strain of the reinforcing cords ranges from −10% to 3% in a portion of the at least one carcass ply located in a region from each of the opposing edges of the widest belt ply of the plurality of belt plies to a position that is 30 mm away widthwisely inwardly of the tire therefrom.

### BACKGROUND OF THE INVENTION

The present invention relates to pneumatic tires for passenger cars, and more particularly, to a pneumatic tire for passenger cars which can improve driving stability.

In general, conventional pneumatic tires for passenger cars include a cross-sectionally triangular bead filler disposed radially outwardly of a bead core embedded in each bead. The bead filler is formed of rubber higher in hardness than that used for tire components surrounding it, and it is known that driving stability can be improved by heightening the bead filler to increase sidewall rigidity (see Japanese patent application Kokai publication No. 9-249006, for example).

However, if the bead filler is heightened as described above, the weight of the bead filler increases accordingly; thus, problems arise such as an increase in tire weight and also deterioration of ride comfort due to an increase in sidewall rigidity.

### SUMMARY OF THE INVENTION

An object of the present invention is to provide a pneumatic tire for passenger cars that can improve driving stability without an increase in weight and without deterioration of ride comfort.

In order to achieve the above object, a pneumatic tire for passenger cars according to the present invention includes right and left beads, a bead core being embedded in each of the beads, a bead filler being disposed radially outwardly of the bead core, the bead filler having a radially outer edge that is located at a position closer to an radially inner side of the tire than a position of 50% of a section height of the tire, at least one carcass ply extending between the right and left beads through a tread, the at least one carcass ply having reinforcing cords that extend in a radial direction of the tire and are disposed at predetermined intervals in a circumferential direction of the tire, a plurality of belt plies being placed radially outwardly of the at least one carcass ply in the tread, wherein a widest belt ply of the plurality of belt plies has opposing edges, the reinforcing cords of the at least one carcass ply having mean residual strain, the mean residual strain being −10% to 3% in a portion of the at least one carcass ply located in a region from each of the opposing edges to a position that is 30 mm away widthwisely inwardly of the tire therefrom.

According to the present invention, since the region in each shoulder area of the tread that greatly affects on driving stability can be made higher in rigidity, driving stability can be enhanced without increasing the height of the bead filler, while an increase in tire weight and deterioration in ride comfort due to an increase in sidewall rigidity are not incurred since it is sufficient simply by changing in the region the mean residual strain of the reinforcing cords of the carcass ply that conventionally exists.

### BRIEF DESCRIPTION OF THE DRAWINGS

FIG. 1 is a partial cross-sectional view showing an embodiment of a pneumatic tire for passenger cars according to the present invention taken in a plane that contains the axis of rotation of the tire.

FIG. 2 illustrates carcass plies and belt plies shown in FIG. 1.

FIG. 3 is a graph showing a distribution state of mean residual strain of the reinforcing cords of a carcass ply in the tread, in which the distance from the tire center line is plotted along the abscissa where the position of the tire center line is 0 and the mean residual strain along the ordinate.

### DESCRIPTION OF THE PREFERRED EMBODIMENTS

An embodiment of the present invention will be described in detail below with reference to the attached drawings.

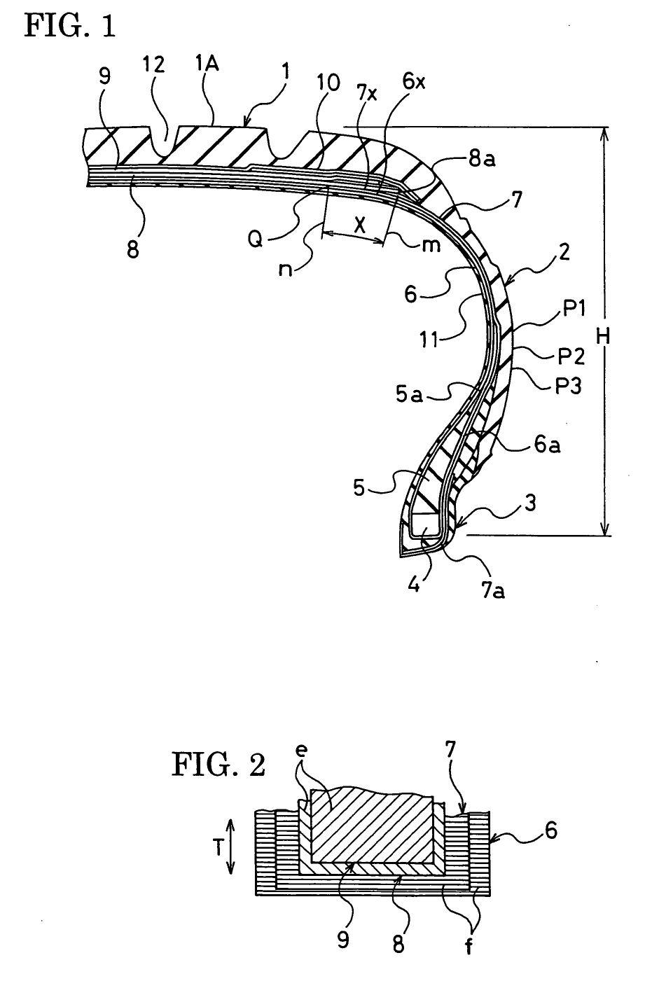

Referring to FIG. 1, there is shown an embodiment of a pneumatic tire for passenger cars according to the present invention; reference numeral 1 denotes a tread, reference numeral 2 denotes a sidewall, and reference numeral 3 denotes a bead.

A bead core 4 is embedded in each of the right and left beads 3, and a cross-sectionally triangular bead filler 5 is disposed radially outwardly of the bead core 4, the bead filler extending to the sidewall 2 side. The bead filler 5, which is formed of rubber higher in hardness than that used for tire components surrounding the bead filler, has a radially outer edge 5a that is located closer to the radially inner side of the tire than the position P1 of 50% of the section height H of the tire from the tire radially inner side, preferably the position P2 of 45%, and more preferably the position P3 of 40%; the height of the bead filler is lowered. The lower limit position of the radially outer edge 5a is suitably adjusted based on tire sizes and types; in general, it is located at a position of about 20% of the tire section height H from the tire radially inner side.

Two carcass plies 6 and 7 extend between the right and left beads 3 through the sidewalls 2 and tread 1; as shown in FIG. 2, the carcass plies each comprise a rubber layer and reinforcing cords f of organic fiber cords such as nylon cords or polyester cords arranged therein, the reinforcing cords f extending in the radial direction of the tire and being disposed at predetermined intervals in the circumferential direction T of the tire. The two carcass plies 6 and 7 includes a first carcass ply 6 disposed inwardly of the tire and a second carcass ply 7 disposed outwardly of the first carcass ply. The first carcass ply 6 has opposing ends 6a, each of which is turned up around the bead core 4 from the inner side of the tire toward the outer side thereof with the bead filler 5 being sandwiched. The second carcass ply 7 has opposing ends 7a, each of which extends toward the inner side of the bead core 4 from the outer side thereof.

Two belt plies 8 and 9 are disposed radially outwardly of the second carcass ply 7 in the tread 1; as shown in FIG. 2, the belt plies each have reinforcing cords e of steel cords that extend in the radial direction of the tire and are arranged at predetermined intervals in the circumferential direction T of the tire. The two belt plies 8 and 9 includes a first belt ply 8 disposed adjacent to the second carcass ply 7 and a second belt ply 9 disposed radially outwardly of the first belt ply, and the first belt ply 8 is greater in width than the second belt ply 9. The oblique reinforcing cords e of the two belt plies 8 and 9 cross each other in such a manner that they are inclined in opposite directions with respect to the circumferential direction T of the tire.

Provided radially outwardly of the second belt ply 9 are belt cover plies 10 that have organic fiber cords such as nylon cords spirally wound around the circumference of the tire. Reference numeral 12 denotes a circumferential groove extending in the circumferential direction T of the tire in the tread surface 1A of the tread 1.

The above carcass plies 6 and 7 have portions 6x and 7x in which the mean residual strain of the reinforcing cords f ranges from −10% to 3%, the portions 6x and 7x being located in regions X from the opposing edges 8a of the wider first belt ply 8 to positions Q that are 30 mm away in length measured along the first belt ply 8 tire-widthwisely inward from the opposing edges 8a (regions between normal lines m drawn to the second carcass ply 7 from the edges 8a and normal lines n drawn to the second carcass ply 7 from the positions Q).

The present inventor has found the following through intense study and repeated experiments on driving stability in pneumatic tires for passenger cars.

That is, an increase in sidewall rigidity makes ride comfort lower, so the present inventor has focused attention to the tread that does not greatly affect on ride comfort. When the tread was checked for driving stability varying tread rigidity, it was found that an increase in tread rigidity in a region from each of the opposing edges of the widest belt ply to a position that is 30 mm away therefrom toward the tire-widthwisely inner side (tire center side) could improve driving stability. Probably, it is speculated that the same effect as a belt ply increases an effective width can be produced, whereby driving stability can be improved.

However, if a new reinforcing member is added in the region to increase tread rigidity, problems arise such as an increase in weight and also deterioration of ground contact characteristics. Therefore, the present inventor noted a carcass ply extending between the beads through the tread.

The carcass ply has reinforcing cords; if the tension of the reinforcing fords can be made higher, the rigidity of the carcass ply increases, whereby tread rigidity can be increased. Accordingly, if the tension of a carcass ply is rendered higher than before in the above-described region that makes a great contribution to driving stability, tread rigidity can be increased in the region without adding any new reinforcing member.

Since a pneumatic tire is produced through a curing step, compressive residual strain (residual strain in a state in which the cords are twisted back and loosed) generally remains in the reinforcing cords of the carcass ply after curing. Studying the relationship between the compressive residual strain and the rigidity of a carcass ply, reinforcing cords having low compressive residual strain are not greatly twisted back, and the rigidity of the carcass ply is high. As the compressive residual strain is smaller, the carcass ply can be greater in rigidity, making further use of the rigidity of the reinforcing cords formed of organic fiber.

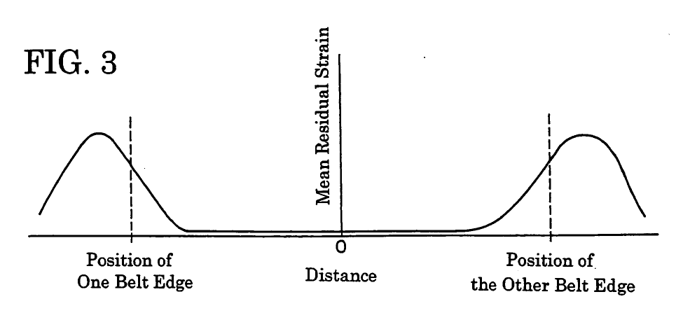

In view of this, when the residual strain of the reinforcing cords of carcass plies of conventional pneumatic tires for passenger cars was measured, the mean residual strain was about 2% (state where the reinforcing cords are twisted back and loosed) in a region of the tread in which belt plies were located. When the mean residual strain of the reinforcing cords of the carcass plies was further checked in detail in the tread, as shown in FIG. 3, the mean residual strain was in such a distribution state that it was low in portions of the reinforcing cords located on the center side of the carcass ply, and high in portions of the reinforcing cords located on both sides thereof, the mean residual strain was 5 to 8% in regions from positions of the opposing edges of the widest belt ply to positions 30 mm away tire-widthwisely inward therefrom, and 0 to 0.5% in the center side region therebetween. Thus, if the mean residual strain of the reinforcing cords can be made lower than the above values, that is, the tension of the reinforcing cords can be increased in the regions from the positions of the opposing edges of the widest belt ply to the positions 30 mm away tire-widthwisely inward therefrom, driving stability can be improved without adding any new reinforcing member.

Therefore, in the present invention, the mean residual strain of the reinforcing cords f ranges from −10% to 3% in the portions 6x and 7x of the carcass plies 6 and 7 that are located in the regions X from the edges 8a of the first belt ply 8 to the positions Q that are 30 mm away tire-widthwisely inward therefrom, as described above. This allows for improvement in driving stability without heightening the bead filler 5, while an increase in tire weight and deterioration in ride comfort due to an increase in rigidity of the sidewalls 2 can be avoided because it is sufficient simply by increasing the rigidity of the carcass plies 6 and 7 that conventionally exist in the regions X utilizing the mean residual strain of the reinforcing cords f.

If the widths of the regions X are less than 30 mm, it is difficult to effectively improve driving stability. The regions X may be widened tire-widthwisely inwardly beyond the positions Q of 30 mm; however, because an improvement effect of driving stability is substantially in the same level even if the regions X are widened beyond the positions Q of 30 mm, it is sufficient to be 30 mm in width. If the regions X are widened to the sidewalls 2 side beyond the edges 8a of the first belt ply 8, it is not preferable because it affects on ride comfort and curing failure may be caused during manufacturing of tires.

If the mean residual strain of the reinforcing cords f is less than −10% in the portions 6x and 7x of the carcass plies 6 and 7, it is not preferable because tire uniformity is abruptly degraded. If the mean residual strain of the reinforcing cords f is greater than 3% in the portions 6x and 7x of the carcass plies 6 and 7, it is difficult to effectively improve driving stability. The mean residual strain of the reinforcing cords f is preferably in the range of −10 to 2%, more preferably −10 to 0% in the portions 6x and 7x of the carcass plies 6 and 7.

In general, a pneumatic tire is manufactured by building a green tire that is smaller in profile (size) than the molding surface of a curing mold, and then by curing the green tire in the curing mold with the green tire being inflated with a bladder to press against the molding surface in a curing process; the above-described pneumatic tire of the present invention can be manufactured by building a green tire in which tread portions located in the regions X are brought closer to a state where the tread portions are pressed against the molding surface of the curing mold, and then by curing the green tire as is conventional, for example.

The pneumatic tire of the present invention including a carcass ply that has reinforcing cords f the mean residual strain of which is a minus value can be obtained by using for the reinforcing cords f of the carcass ply organic fiber cords with high heat shrinkages obtained by changing the method of dipping treatment thereof.

In the above embodiment of the present invention, the mean residual strain of the reinforcing cords f ranges as described above in the portions 6x and 7x of the two carcass plies 6 and 7; however, the mean residual strain of the reinforcing cords f may range as described above in the portions of at least one of the carcass plies.

There is shown in the above embodiment an example of a pneumatic tire for passenger cars having two carcass plies; however, the pneumatic tire of the present invention may be one having at least one carcass ply. The pneumatic tire of the present invention may be one having two or more belt plies; in this case, the regions X range from the opposing edges of the widest belt ply to positions that are 30 mm away tire-widthwisely inward therefrom along the widest belt ply.

In the pneumatic tire of the present invention, the mean residual strain of the reinforcing cords f in each portion 6x of the first carcass ply 6 is measured as follows.

First, the inner liner 11 is removed from the pneumatic tire to expose the first carcass ply 6. Marking is then applied to a plurality of (two to five) reinforcing cords f of the first carcass ply 6 that are arbitrary measurement targets at a position corresponding to the edge 8a of the first belt ply 8 and a position corresponding to the position Q that is 30 mm away from the edge 8a. A non-expandable tape is stuck to the marked reinforcing cords f therealong to transfer the markings to the non-expandable tape. Thereafter, the plurality of marked reinforcing cords f were extracted from the tire, and the residual strain of each marked reinforcing cord f in the portion 6x of the first carcass ply 6 is calculated based on the length between the markings on each extracted reinforcing cord f and the length between the corresponding markings transferred to the non-expandable tape.

More specifically, if M is the length between the positions marked on each extracted reinforcing cord f corresponding to the edge 8a of the first belt ply 8 and to the position Q, and if M′ is the length between the positions corresponding to the edge 8a of the first belt ply 8 and to the position Q on the non-expandable tape to which the markings are transferred, the residual strain S (%) of each reinforcing cord f in the region X is calculated by the following equation.
S=100(M−M′)/M′

The above measurement is performed at six substantially evenly spaced locations around the circumference of the tire; the average of the obtained values of residual strain S is the mean residual strain of the reinforcing cords f in the portion 6x of the first carcass ply 6.

The measurement of the mean residual strain of the reinforcing cords f in the portion 7x of the second carcass ply 7 is performed as in the above after removal of the first carcass ply 6.

### EXAMPLE

Prepared, respectively, were test tires according to the present invention tires 1 to 4, comparison tire and conventional tire, each having a tire size of 225/50R16 and a tire construction shown in FIG. 1, in which the mean residual strain of the reinforcing cords (polyester cords) in the portions of the carcass plies in the regions X was as shown in Table 1.

In each test tire, the radially outer edge of each bead filler was located at a position of 45% of the tire section height H.

The test tires were seated on standard rims, inflated to an air pressure of 220 kPa, and subjected to evaluation testing for driving stability according to the following testing method, obtaining the results shown in Table 1.

Driving Stability

The test tires were mounted on a vehicle of 3000 cc displacement; feeling testing for driving stability was conducted by a test driver on a test course. The evaluation results are represented by a five-point method (0.5 point increments) where the conventional tire is 3. As the point value is greater, driving stability is better. It should be noted that “3+” in Table 1 means that the driver felt that it was slightly better than “3”, but there was no significant difference therebetween.

TABLE 1

| | Mean Residual | |
|---|---|---|
| | Strain (%) | Driving Stability |
| Conventional | 5.0 | 3 |
| Tire | | |
| Comparison Tire | 3.5 | 3+ |
| Present | 3.0 | 3.5 |
| Invention Tire 1 | | |
| Present | 1.5 | 3.5 |
| Invention Tire 2 | | |
| Present | 0.5 | 4.0 |
| Invention Tire 3 | | |
| Present | −0.5 | 4.0 |
| Invention Tire 4 | | |

As can be seen from Table 1, the present invention tires can effectively improve driving stability.

What is claimed is:

1. A pneumatic tire for passenger cars having right and left beads, a bead core being embedded in each of the beads, a bead filler being disposed radially outwardly of the bead core, the bead filler having a radially outer edge that is located at a position closer to an radially inner side of the tire than a position of 50% of a section height of the tire, at least one carcass ply extending between the right and left beads through a tread, the at least one carcass ply having reinforcing cords that extend in a radial direction of the tire and are disposed at predetermined intervals in a circumferential direction of the tire, a plurality of belt plies being placed radially outwardly of the at least one carcass ply in the tread,
wherein a widest belt ply of the plurality of belt plies has opposing edges, the reinforcing cords of the at least one carcass ply having mean residual strain, the mean residual strain being −10% to 3% in a portion of the at least one carcass ply located in a region from each of the opposing edges to a position that is 30 mm away widthwisely inwardly of the tire therefrom.

2. A pneumatic tire for passenger cars according to claim 1, wherein the mean residual strain of the reinforcing cords is −10% to 2% in the portion of the at least one carcass ply.

3. A pneumatic tire for passenger cars according to claim 2, wherein the mean residual strain of the reinforcing cords is −10% to 0% in the portion of the at least one carcass ply.

4. A pneumatic tire for passenger cars according to claim 1, wherein the radially outer edge of the bead filler is located at a position closer to the radially inner side of the tire than a position of 45% of the section height of the tire.

5. A pneumatic tire for passenger cars according to claim 4, wherein the radially outer edge of the bead filler is located at a position closer to the radially inner side of the tire than a position of 40% of the section height of the tire.

6. A pneumatic tire for passenger cars according to claim 1, wherein the at least one carcass ply comprises a first carcass ply and a second carcass ply disposed outwardly of the first carcass ply, the first carcass ply having opposing ends each turning up around the bead core from an inner side of the tire toward an outer side thereof, the second carcass ply having opposing ends each extending inwardly from an outer side of the bead core.

7. A pneumatic tire for passenger cars according to claim 1, wherein the plurality of belt plies include a first belt ply adjacent to the at least one carcass ply and a second belt ply disposed radially outwardly thereof, the widest belt ply being the first belt ply.

8. A pneumatic tire for passenger cars according to claim 1, the reinforcing cords of the at least one carcass ply is formed from organic fiber cords.
